(19) United States
(12) Patent Application Publication
(10) Pub. No.: US 2010/0237136 A1
(43) Pub. Date: Sep. 23, 2010

(54) GOLF CLUB HOZEL BRAZING

(76) Inventors: Richard De La Cruz, Carlsbad, CA (US); Richard D. De La Cruz, Encinitas, CA (US)

Correspondence Address: STEVEN W. WEBB, 825 College Blvd., Suite 102620, Oceanside, CA, 92057, US

(21) Appl. No.: 12/407,944

(22) Filed: Mar. 20, 2009

(51) Int. Cl. B23K 31/02; B23K 1/20

(52) U.S. Cl. 228/164

(57) ABSTRACT

A method of applying brazing to the task of attaching a golf club head to a hozel is presented. Brazing is preferable over gluing because of its improves strength characteristics, and preferable to welding because their is no risk of deforming the head or hozel because of high welding temperatures, and there is no welding bead to grind down.

### FIELD OF THE INVENTION

The present invention relates to a method for connecting a golf club head to a golf club shaft hozel.

### BACKGROUND OF THE INVENTION

When connecting a golf club head to a golf club shaft hozel, the hozel is usually connected to the head by means of welding or gluing, each method possessing certain drawbacks. With welding, the connection is poor if welding club head and the hozel are made of different materials. Welding temperatures higher than the melting point of one of the metals deforms the piece comprised of that metal, and the joint surface between the golf club head and the hozel will not be a flat and smooth surface. In addition, stress fractures and other deformities can be produced by using too high a welding temperature.

Gluing possesses its own drawbacks, primarily lack of strength and long-term durability. While deformation of the materials making up the golf club is minimized, there is a distinct risk that during use, the head will separate from the hozel. A technique of directly bonding and combining the head and hozel with a high strength glue under room temperature is available in the prior art. The upper limit of high-strength bonding glue does not provide enough combining strength to support the stresses of golf club swings and ball striking.

### SUMMARY OF THE INVENTION

There are several brazing joint processes available in the conventional art. These processes are performed on golf club heads and are used to combine striking plates to heads, and the like.

The present invention applies one of several brazing techniques to the process of joining a golf club head and shaft hozel. The application is applicable to steel and stainless steel head and hozel components, and relies on well-established brazing techniques.

Conventional brazing using steel does not introduce and stress fractures or deformities to the materials via the joining process. The brazing produces a strong join and can be performed without resorting to vacuum or special atmospheres to avoid oxidation problems.

### DESCRIPTION OF THE FIGURES

FIG. 1. View of the hozel-head system

### DETAILED SPECIFICATION

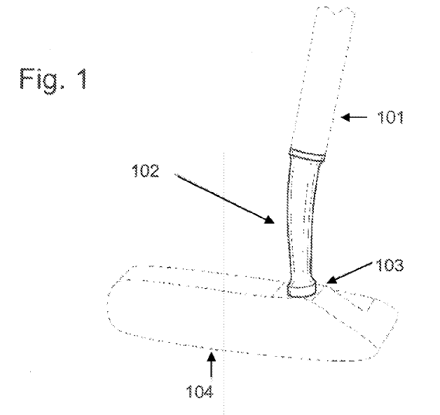

As in FIG. 1, a typical golf possesses a club head 104, a hozel 102, a shaft 101, and a join 103. Joins 103, where the hozel is inserted into the golf club head 104 have typically been made by welding or gluing, holding the hozel firmly to the head, but often leaving unsightly beads. Welding can also produce deformities in both the hozel 102 and the club head 104 when the welding temperature exceeds the melting temperature of one or both of the metals comprising the structure.

The present invention is the application of brazing to creating the join 103 between hozel 102 and club head 104. The techniques involves using any of a number of brazing metals such as gold, cupric-gold, and nickel and performing the brazing in either a vacuum or an inert atmosphere. The brazed join 103 does not need to be ground down.

The invention can be applied to steel and stainless steel club heads 104, and makes use of any of several well-understood brazing techniques. The join 103 produced is stronger than gluing and does not produce a welding bead not risk deforming the club head 104 or hozel 102. The preferred method is applying cupric-gold alloy using an inert gas brazing technique.

Although the invention has been described and a preferred embodiment has been provided, equivalent features may be employed and substitutions made within this specification without departing from the scope of the invention as recited in the claims.

What is claimed is:

1. (canceled)

2. (canceled)

3. A method of joining a golf club head to a golf club hosel, comprised of the steps of
manufacturing a golf club head and a golf club hosel out of a rigid material,
machining the golf club head and golf club hosel such that the hosel can be inserted easily into a hole in the golf club head,
using a brazing technique and a selected brazing material to fixedly attach the golf club hosel to the golf club head,
the brazing technique selected from a group comprised of inert gas brazing and vacuum brazing, the brazing material selected from a group comprised of gold, cupric-gold, and nickel alloys, and the rigid material of the golf club head and golf club hosel selected from a group comprised of stainless steel and steel.
